(19) United States
(12) Patent Application Publication
(10) Pub. No.: US 2020/0123344 A1
(43) Pub. Date: Apr. 23, 2020

(54) COLOURED PLASTICS BASED ON CROSSLINKED POLYISOCYANATES

(71) Applicant: Covestro Deutschland AG, Leverkusen (DE)

(72) Inventors: Paul HEINZ, Leverkusen (DE); Heiko HOCKE, Leverkusen (DE); Dirk ACHTEN, Leverkusen (DE); Joerg TILLACK, Solingen (DE)

(21) Appl. No.: 16/626,136

(22) PCT Filed: Jun. 22, 2018
(86) PCT No.: PCT/EP2018/066752

§ 371 Date: Dec. 23, 2019

(30) Foreign Application Priority Data
Jun. 28, 2017 (EP) 17178496.0

(51) Int. Cl. C08K 5/18; C08G 18/79; C08G 18/48; C08K 3/04; C08K 3/30

(52) U.S. Cl. CPC C08K 5/18; C08G 18/792; C08K 2003/3036; C08K 3/04; C08K 3/30; C08G 18/4833

(57) ABSTRACT

The invention relates to materials made from cross-linked isocyanates which are coloured by pigments and/or pigment formulations.

The present invention relates to materials made from crosslinked isocyanates colored by pigments and/or pigment formulations.

Plastics obtainable by catalytic crosslinking of isocyanate groups of aliphatic polyisocyanates have barely been described in literature.

The thesis by Theo Flipsen: “Design, synthesis and properties of new materials based on densely crosslinked polymers for polymer optical fiber and amplifier applications”, Rijksuniversiteit Groningen, 2000 describes the trimerization of monomeric HDI with a neodymium/crown ether complex as catalyst. The polyisocyanurate obtained, which is said to have good optical, thermal and mechanical properties, was examined in the context of the thesis for its suitability for optical applications, especially as polymeric optical fiber.

WO 2015/166983 describes the use of isocyanurate polymers for the encapsulation of light-emitting diodes. It is explicitly emphasized that only those polymers that contain allophanate groups have satisfactory properties.

Since both publications are concerned with the production of optical components, there has been no discussion of the use of dyes, nor would it make much sense for the desired end use.

In a first embodiment, the present invention relates to a colored plastic obtainable by the catalytic crosslinking of a polyisocyanate composition A in the presence of at least one pigment, characterized in that (i) the plastic contains at least 5% by weight of a fibrous filler having an aspect ratio of at least 100, based on the sum total of the weights of the polyisocyanate composition A, dye and fibrous filler; and (ii) the nitrogen components bound within uretdione, isocyanurate, biuret and iminooxadiazinedione structures add up to at least 60% of the total nitrogen content of the polyisocyanate composition A.

“Isocyanate-reactive groups” in the context of this application are hydroxyl, amino and thiol groups. More preferably, the molar ratio of isocyanate groups to isocyanate-reactive groups in the reaction mixture on commencement of the catalytic crosslinking is at least 5:1, preferably at least 10:1. The “reaction mixture” consists of all components required for a catalytic crosslinking of the polyisocyanate composition A: the dye, the fibrous fillers, the polyisocyanate composition A and all further components. The reaction mixture thus gives rise to the colored plastic of the invention.

The combination of fibrous fillers with pigments is particularly advantageous because the color effect of a given proportion of the pigment in the presence of a fibrous filler is greater than in its absence. Thus, a lower pigment concentration is required for the same visual impression. Since pigments at least do not make a positive contribution to the stability of the plastic, and in many cases actually weaken it, a minimum pigment content is advantageous.

### Polyisocyanate Composition A

The term “polyisocyanate” as used here is a collective term for compounds containing two or more isocyanate groups (this is understood by the person skilled in the art to mean free isocyanate groups of the general structure —N═C═O) in the molecule. The simplest and most important representatives of these polyisocyanates are the diisocyanates. These have the general structure O═C═N—R—N═C═O where R typically represents aliphatic, alicyclic and/or aromatic radicals.

Because of the polyfunctionality (≥2 isocyanate groups), it is possible to use polyisocyanates to prepare a multitude of polymers (e.g. polyurethanes, polyureas, polyuretdiones, polycarbodiimides and polyisocyanurates) and low molecular weight compounds (for example urethane prepolymers or those having uretdione, isocyanurate, allophanate, biuret, iminooxadiazinedione and/or oxadiazinetrione structure).

Where general reference is made to “polyisocyanates” in the context of the present invention, this means monomeric and/or oligomeric polyisocyanates. For the understanding of many aspects of the invention, however, it is important to distinguish between monomeric diisocyanates and oligomeric polyisocyanates. Where reference is made here to “oligomeric polyisocyanates”, this means polyisocyanates formed from at least two monomeric diisocyanate molecules, i.e. compounds that constitute or contain a reaction product formed from at least two monomeric diisocyanate molecules. The “oligomeric polyisocyanate” has preferably been formed from 2 to 20, or preferably from 2 to 10, monomeric diisocyanate molecules.

The preparation of oligomeric polyisocyanates from monomeric diisocyanates is also referred to here as modification of monomeric diisocyanates. This “modification” as used here means the reaction of monomeric diisocyanates to give oligomeric polyisocyanates having uretdione, isocyanurate, allophanate, biuret, iminooxadiazinedione and/or oxadiazinetrione structure. Especially when catalyst solvents that contain hydroxyl groups are used, the oligomeric polyisocyanates that are suitable in accordance with the invention also contain urethane and allophanate structures. However, it is preferable that allophanate and urethane structures make up only a small proportion of the total amount of structures that bring about the oligomerization.

For example, hexamethylene diisocyanate (HDI) is a “monomeric diisocyanate” since it contains two isocyanate groups and is not a reaction product of at least two polyisocyanate molecules:

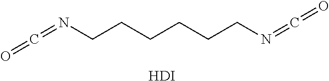

By contrast, reaction products of at least two HDI molecules which still have at least two isocyanate groups are “oligomeric polyisocyanates” in the context of the invention. Representatives of such “oligomeric polyisocyanates” are, proceeding from monomeric HDI, for example, HDI isocyanurate and HDI biuret, each of which is formed from three monomeric HDI units:

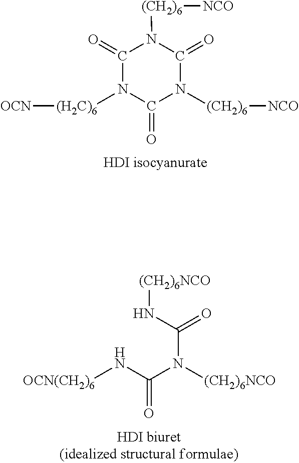

“Polyisocyanate composition A” in the context of the invention refers to the isocyanate component in the initial reaction mixture. In other words, this is the sum total of all compounds in the initial reaction mixture that have isocyanate groups. The polyisocyanate composition A is thus used as reactant in the process of the invention. Where reference is made here to “polyisocyanate composition A”, especially to “providing the polyisocyanate composition A”, this means that the polyisocyanate composition A exists and is used as reactant.

In principle, the polyisocyanate composition A may contain monomeric and oligomeric polyisocyanates as individual components or in any mixing ratio.

Since oligomeric polyisocyanates, however, are less volatile than monomeric polyisocyanates, it may be desirable for reasons of occupational safety to reduce the proportion of monomeric polyisocyanates in the polyisocyanate composition A as far as possible. For that reason, the polyisocyanate composition A, in a preferred embodiment of the present invention, comprises oligomeric polyisocyanates and is low in monomeric diisocyanates, “low in monomeric diisocyanates” meaning that the polyisocyanate composition A has a content of monomeric diisocyanates of ≤20% by weight, preferably <5% by weight, more preferably <1% by weight, most preferably <0.5% by weight.

“Low in monomers” and “low in monomeric polyisocyanates” is used here synonymously in relation to the polyisocyanate composition A.

In one embodiment of the invention, the polyisocyanate composition A consists entirely or to an extent of at least 80%, 85%, 90%, 95%, 98%, 99% or 99.5% by weight, based in each case on the weight of the polyisocyanate composition A, of oligomeric polyisocyanates. Preferably, the polyisocyanate composition A consists entirely or to an extent of at least 99.7%, 99.8% or 99.9% by weight, based in each case on the weight of the polyisocyanate composition A, of oligomeric polyisocyanates. This content of oligomeric polyisocyanates is based on the polyisocyanate composition A, meaning that they are not formed, for instance, as intermediate during the process of the invention, but are already present in the polyisocyanate composition A used as reactant on commencement of the reaction.

The polyisocyanate composition A used is low in monomers. In practice, this can especially be achieved by using, as polyisocyanate composition A, oligomeric polyisocyanates, in the preparation of which the actual modification reaction has been followed in each case by at least one further process step for removal of the unconverted excess monomeric polyisocyanates. This removal of monomers can be effected in a particularly practical manner by processes known per se, preferably by thin-film distillation under high vacuum or by extraction with suitable solvents that are inert toward isocyanate groups, for example aliphatic or cycloaliphatic hydrocarbons such as pentane, hexane, heptane, cyclopentane or cyclohexane.

In one embodiment of the invention, the polyisocyanate composition A of the invention is obtained by modifying monomeric polyisocyanates with subsequent removal of unconverted monomers.

In one embodiment of the invention, the polyisocyanate composition A comprises oligomeric polyisocyanates and includes 20%, 15%, 10%, 5%, 4%, 3%, 2%, 1% or 0.5% by weight, based in each case on the weight of the polyisocyanate composition A, of monomeric polyisocyanates. Preferably, the polyisocyanate composition A comprises oligomeric polyisocyanates and includes not more than 0.3%, 0.2% or 0.1% by weight, based in each case on the weight of the polyisocyanate composition A, of monomeric polyisocyanates.

In a particular embodiment of the invention, a polymer composition A which comprises oligomeric polyisocyanates and is free or essentially free of monomeric polyisocyanates is used. “Essentially free” means here that the content of monomeric polyisocyanates is not more than 0.5% by weight, preferably not more than 0.3%, 0.2% or 0.1% by weight, based in each case on the weight of the polyisocyanate composition A. Surprisingly, this leads to distinctly lower volume shrinkage on crosslinking. The lower exothermicity of this reaction additionally still makes it possible to obtain high-quality polyisocyanurate polymers, in spite of faster and more severe reaction conditions. In addition, polyisocyanates having a low monomer content have a lower risk potential, which very much simplifies the handling and processing thereof.

On the other hand, it is possible through the controlled addition of monomeric polyisocyanates to easily adjust the viscosity of the polyisocyanate composition A to the process conditions required. In this case, the monomers added act as reactive diluents and are also incorporated into the polymer matrix on crosslinking.

In another preferred embodiment of the process of the invention, a polyisocyanate composition A rich in monomeric polyisocyanates is used. Such a polyisocyanate composition contains high proportions of monomeric isocyanates. These proportions are preferably at least 20% by weight, more preferably at least 40% by weight, even more preferably at least 60% by weight and most preferably at least 80% by weight.

In a further particular embodiment of the invention, both a low-monomer polyisocyanate composition A and a monomer-rich polyisocyanate composition A may comprise one or more extra monomeric diisocyanates. In this context, “extra monomeric diisocyanate” means that it differs from the monomeric polyisocyanates which make up the greatest proportion of the monomeric polyisocyanates present in the polyisocyanate composition A or the monomeric polyisocyanates which have been used for preparation of the oligomeric polyisocyanates present in the polyisocyanate composition A. Addition of extra monomeric diisocyanate can be advantageous for achieving specific technical effects, for example a particular hardness, a desired elasticity or elongation, or a desired glass transition temperature or viscosity, in the course of processing. Results of particular practical relevance are established when the polyisocyanate composition A has a proportion of extra monomeric diisocyanate in the polyisocyanate composition A of not more than 49% by weight, especially not more than 25% by weight or not more than 10% by weight, based in each case on the weight of the polyisocyanate composition A. Preferably, the polyisocyanate composition A has a content of extra monomeric diisocyanate of not more than 5% by weight, preferably not more than 2.0% by weight, more preferably not more than 1.0% by weight, based in each case on the weight of the polyisocyanate composition A.

In a further particular embodiment of the process of the invention, the polyisocyanate composition A may contain monomeric monoisocyanates having an isocyanate functionality of 1 or monomeric isocyanates having an isocyanate functionality greater than 2, i.e. having more than two isocyanate groups per molecule. The addition of monomeric monoisocyanates having an isocyanate functionality of 1 or monomeric isocyanates having an isocyanate functionality greater than two has been found to be advantageous in order to influence the network density and/or glass transition temperature of the polyisocyanurate plastic. The mean isocyanate functionality of the polyisocyanate composition A is greater than 1, preferably greater than 1.25, especially greater than 1.5, more preferably greater than 1.75 and most preferably greater than 2. The mean isocyanate functionality of the polyisocyanate composition A can be calculated by dividing the sum total of the isocyanate functionalities of all polyisocyanate molecules present in the polyisocyanate composition A by the number of polyisocyanate molecules present in the polyisocyanate composition A. Results of particular practical relevance are established when the polyisocyanate composition A has a proportion of monomeric monoisocyanates having an isocyanate functionality of 1 or monomeric isocyanates having an isocyanate functionality greater than two in the polyisocyanate composition A of not more than 20% by weight, especially not more than 15% by weight or not more than 10% by weight, based in each case on the weight of the polyisocyanate composition A. Preferably, the polyisocyanate composition A has a content of monomeric monoisocyanates having an isocyanate functionality of 1 or monomeric isocyanates having an isocyanate functionality greater than 2 of not more than 5% by weight, preferably not more than 2.0% by weight, more preferably not more than 1.0% by weight, based in each case on the weight of the polyisocyanate composition A. Preferably, no monomeric monoisocyanate having an isocyanate functionality of 1 or monomeric isocyanate having an isocyanate functionality greater than 2 is used in the trimerization reaction of the invention.

The oligomeric polyisocyanates described here are typically obtained by modifying simple aliphatic, cycloaliphatic, araliphatic and/or aromatic monomeric diisocyanates or mixtures of such monomeric diisocyanates.

The oligomeric polyisocyanates may, in accordance with the invention, especially have uretdione, urethane, isocyanurate, allophanate, biuret, iminooxadiazinedione and/or oxadiazinetrione structure. In one embodiment of the invention, the oligomeric polyisocyanates have at least one of the following oligomeric structure types or mixtures thereof:

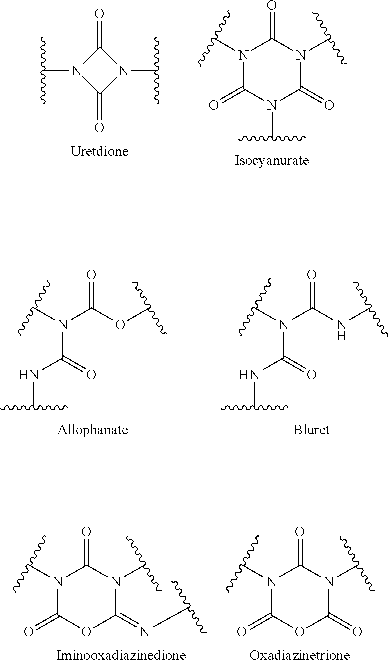 [SMILES: *N1C(=O)N(*)C1=O ; *n1c(=O)n(*)c(=O)n(*)c1=O ; *NC(=O)N(*)C(=O)O* ; *NC(=O)N(*)C(=O)N* ; */N=c1/oc(=O)n(*)c(=O)n1* ; *n1c(=O)oc(=O)n(*)c1=O]

It has been found that, surprisingly, it can be advantageous to use oligomeric polyisocyanates that are a mixture of at least two oligomeric polyisocyanates, wherein the at least two oligomeric polyisocyanates differ in terms of structure. The structure is preferably selected from the group consisting of uretdione, urethane, isocyanurate, allophanate, biuret, iminooxadiazinedione and oxadiazinetrione structure or mixtures of at least two of these. Starting mixtures of this kind can especially lead, by comparison with trimerization reactions with oligomeric polyisocyanates of just one defined structure, to an effect on the Tg value, which is advantageous for many applications.

Preference is given to using, in the process of the invention, a polyisocyanate composition A consisting of at least one oligomeric polyisocyanate having biuret, allophanate, isocyanurate and/or iminooxadiazinedione structure and mixtures thereof. Preference is given to using, in the process of the invention, a polyisocyanate composition A containing not more than 20 mol %, preferably not more than 10 mol %, more preferably not more than 5 mol %, even more preferably not more than 2 mol % and especially not more than 1 mol % of oligomeric polyisocyanates having urethane structure, for example urethane prepolymers. In a particularly preferred embodiment of the invention, the polyisocyanate composition A, however, while complying with the aforementioned upper limits, is not entirely free of urethane and allophanate groups. The polyisocyanate composition A preferably contains at least 0.1 mol % of urethane and/or allophanate groups.

In another embodiment, the polyisocyanate composition A containing oligomeric polyisocyanates is one containing only a single defined oligomeric structure, for example exclusively or for the most part isocyanurate structure. In general, as a result of the preparation, however, several different oligomeric structures are always present alongside one another in the polyisocyanate composition A.

In the context of the present invention, a polyisocyanate composition A is regarded as a polyisocyanate composition of a single defined oligomeric structure when an oligomeric structure selected from the group consisting of uretdione, urethane, isocyanurate, allophanate, urea, biuret, iminooxadiazinedione and oxadiazinetrione structures is present to an extent of at least 50 mol %, preferably at least 60 mol %, more preferably at least 70 mol %, especially preferably at least 80 mol % and particularly at least 90 mol %, based in each case on the sum total of all oligomeric structures from the group consisting of uretdione, urethane, isocyanurate, allophanate, urea, biuret, iminooxadiazinedione and oxadiazinetrione structure present in the polyisocyanate composition A. In the process of the invention, in a further embodiment, a polyisocyanate composition A of a single defined oligomeric structure is thus used, the oligomeric structure being selected from the group consisting of uretdione, isocyanurate, allophanate, biuret, iminooxadiazinedione and oxadiazinetrione structures.

In a further embodiment, the oligomeric polyisocyanates are those which have mainly an isocyanurate structure and which may contain the abovementioned uretdione, urethane, allophanate, urea, biuret, iminooxadiazinedione and/or oxadiazinetrione structure only as by-products. Thus, one embodiment of the invention envisages the use of a polymer composition A of a single defined oligomeric structure, the oligomeric structure being an isocyanurate structure and being present to an extent of at least 50 mol %, preferably at least 60 mol %, more preferably at least 70 mol %, especially preferably at least 80 mol % and particularly at least 90 mol %, based in each case on the sum total of the oligomeric structures from the group consisting of uretdione, urethane, isocyanurate, allophanate, urea, biuret, iminooxadiazinedione and oxadiazinetrione structure present in the polyisocyanate composition A.

It is likewise possible in accordance with the invention to use oligomeric polyisocyanates having very substantially no isocyanurate structure, and containing mainly at least one of the abovementioned uretdione, biuret, iminooxadiazinedione and/or oxadiazinetrione structure types. In a particular embodiment of the invention, the polyisocyanate composition A consists to an extent of at least 50 mol %, preferably at least 60 mol %, more preferably at least 70 mol %, especially preferably at least 80 mol % and particularly at least 90 mol %, based in each case on the sum total of the oligomeric structures from the group consisting of uretdione, urethane, isocyanurate, allophanate, urea, biuret, iminooxadiazinedione and oxadiazinetrione structure present in the polyisocyanate composition A, of oligomeric polyisocyanates having a structure type selected from the group consisting of uretdione, allophanate, biuret, iminooxadiazinedione and/or oxadiazinetrione structure.

A further embodiment of the invention envisages the use of a low-isocyanurate polyisocyanate composition A having, based on the sum total of the oligomeric structures from the group consisting of uretdione, urethane, isocyanurate, allophanate, biuret, iminooxadiazinedione and oxadiazinetrione structure present in the polyisocyanate composition A, less than 50 mol %, preferably less than 40 mol %, more preferably less than 30 mol % and especially preferably less than 20 mol %, 10 mol % or 5 mol % of isocyanurate structures.

A further embodiment of the invention envisages the use of a polyisocyanate composition A of a single defined oligomeric structure type, said oligomeric structure type being selected from the group consisting of uretdione, biuret, iminooxadiazinedione and/or oxadiazinetrione structure and this structure type being present to an extent of at least 50 mol %, preferably 60 mol %, more preferably 70 mol %, especially preferably 80 mol % and particularly 90 mol %, based on the sum total of the oligomeric structures from the group consisting of uretdione, urethane, isocyanurate, allophanate, biuret, iminooxadiazinedione and oxadiazinetrione structure present in the polyisocyanate composition A.

The proportions of uretdione, urethane, isocyanurate, allophanate, urea, biuret, iminooxadiazinedione and/or oxadiazinetrione structure in the polyisocyanate composition A can be calculated, for example, from the integrals of proton-decoupled 13C NMR spectra, since the oligomeric structures mentioned give characteristic signals, and each is based on the sum total of uretdione, urethane, isocyanurate, allophanate, urea, biuret, iminooxadiazinedione and/or oxadiazinetrione structures present in the polyisocyanate composition A.

Irrespective of the underlying oligomeric structure type (uretdione, urethane, isocyanurate, allophanate, urea, biuret, iminooxadiazinedione and/or oxadiazinetrione structure), the polyisocyanate composition A for use in the process of the invention preferably has a (mean) NCO functionality of >1.0 to 6.0, preferably 1.5 to 5.0, more preferably of 2.0 to 4.5.

Particularly useful results are obtained when the polyisocyanate composition A to be used in accordance with the invention has a content of isocyanate groups of 8.0% to 60.0% by weight. It has been found to be of particular practical relevance when the polyisocyanate composition A of the invention has a content of isocyanate groups of 14.0% to 30.0% by weight, based in each case on the weight of the polyisocyanate composition A.

Preparation processes for oligomeric polyisocyanates having uretdione, urethane, isocyanurate, allophanate, urea, biuret, iminooxadiazinedione and/or oxadiazinetrione structure are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

In an additional or alternative embodiment of the invention, the polyisocyanate composition A is defined in that it contains oligomeric polyisocyanates which have been obtained from monomeric polyisocyanates, irrespective of the nature of the modification reaction used, with observation of an oligomerization level of 5% to 90%, preferably 30% to 75%, more preferably 40% to 60%. “Oligomerization level” is understood here to mean the percentage of isocyanate groups originally present in the starting mixture which is converted during the process for preparation of the polyisocyanate composition A to form uretdione, urethane, isocyanurate, allophanate, urea, biuret, iminooxadiazinedione and/or oxadiazinetrione structures.

Suitable starting compounds for the oligomeric polyisocyanates are any desired monomeric polyisocyanates obtainable in various ways, for example by phosgenation in the liquid or gas phase or by a phosgene-free route, for example by thermal urethane cleavage. Particularly good results are established when the monomeric polyisocyanates are monomeric diisocyanates. Preferred monomeric diisocyanates are those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 2,4′- and 4,4′-diisocyanatodicyclohexylmethane (H12MDI), 1-isocyanato-1-methyl-4(3)-isocyanatomethylcyclohexane, 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-β-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates. Further diisocyanates which are likewise suitable are additionally found, for example, in Justus Liebigs Annalen der Chemie Volume 562 (1949) p. 75-136.

In addition, it is also possible in the process of the invention to use conventional prepolymers bearing aliphatic or aromatic isocyanate end groups, for example polyether, polyester or polycarbonate prepolymers bearing aliphatic or aromatic isocyanate end groups, as mono- and polyisocyanates in the polyisocyanate composition A.

Suitable monomeric monoisocyanates which can optionally be used in the polyisocyanate composition A are, for example, n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- or 4-methylcyclohexyl isocyanate or any desired mixtures of such monoisocyanates. An example of a monomeric isocyanate having an isocyanate functionality greater than two which can optionally be added to the polyisocyanate composition A is 4-isocyanatomethyloctane 1,8-diisocyanate (triisocyanatononane; TIN).

In one embodiment of the invention, the polyisocyanate composition A contains not more than 80% by weight, especially not more than 50% by weight, not more than 25% by weight, not more than 10% by weight, not more than 5% by weight or not more than 1% by weight, based in each case on the weight of the polyisocyanate composition A, of aromatic polyisocyanates. As used here, “aromatic polyisocyanate” means a polyisocyanate having at least one aromatically bonded isocyanate group. Aromatically bonded isocyanate groups are understood to mean isocyanate groups bonded to an aromatic hydrocarbyl radical.

In a preferred embodiment of the process of the invention, a polyisocyanate composition A having exclusively aliphatically and/or cycloaliphatically bonded isocyanate groups is used. Aliphatically and cycloaliphatically bonded isocyanate groups are respectively understood to mean isocyanate groups bonded to an aliphatic and cycloaliphatic hydrocarbyl radical.

In another preferred embodiment of the process of the invention, a polyisocyanate composition A consisting of or comprising one or more oligomeric polyisocyanates is used, where the one or more oligomeric polyisocyanates has/have exclusively aliphatically and/or cycloaliphatically bonded isocyanate groups.

In a further embodiment of the invention, the polyisocyanate composition A consists to an extent of at least 55%, 70%, 80%, 85%, 90%, 95%, 98% or 99% by weight, based in each case on the weight of the polyisocyanate composition A, of oligomeric polyisocyanates having exclusively aliphatically and/or cycloaliphatically bonded isocyanate groups. Practical experiments have shown that particularly good results can be achieved with polyisocyanate compositions A in which the oligomeric polyisocyanates present therein have exclusively aliphatically and/or cycloaliphatically bonded isocyanate groups.

In a particularly preferred embodiment of the process of the invention, a polyisocyanate composition A is used which consists of or comprises one or more oligomeric polyisocyanates, where the one or more oligomeric polyisocyanates is/are based on 1,4-diisocyanatobutane (BDI), 1,5-diisocyanatopentane (PDI), 1,6-diisocyanatohexane (HDI), isophorone diisocyanate (IPDI) or 4,4′-diisocyanatodicyclohexylmethane (H12MDI) or mixtures thereof.

### Shaped Body

The colored plastic of the invention preferably takes the form of a shaped body. The term “shaped body” in the present application denotes a body having an extent in each of the three dimensions of at least 1 mm, preferably at least 2 mm, more preferably additionally in at least two of the three dimensions of at least 20 mm, and most preferably in at least two of the three dimensions of 50 mm.

### Dye

A “dye” in the context of the present patent application is any compound capable of imparting a color to the crosslinked polyisocyanate composition A which is different from the color of the crosslinked polyisocyanate composition A in the absence of the dye. Dyes may be soluble in the polyisocyanate composition A, but may also take the form of insoluble particles. The latter are also referred to in this application as “pigments”. Pigments have a diameter of not more than 200 m, preferably not more than 100 μm, more preferably not more than 10 μm and most preferably not more than 5 μm. The particle diameters are preferably ascertained by means of light microscopy or electron microscopy.

The invention requires mixing of the dye with the polyisocyanate composition A prior to catalytic crosslinking thereof in such a way that it is distributed homogeneously therein and enables uniform coloring of the plastic resulting from the crosslinking. For this purpose, soluble dyes are dissolved in the polyisocyanate composition A; pigments are dispersed therein. If necessary, dispersants known to the person skilled in the art are used here. Preferably, the colored plastic includes the dye in an amount within a range from 0.01% to 20% by weight, or preferably within a range from 0.05% to 15% by weight, or preferably within a range from 0.1% to 10% by weight, or preferably within a range from 0.2% to 4% by weight, based on the total weight of the colored plastic.

In a preferred embodiment, the dye is an inorganic pigment, for example a metal powder (aluminum, copper, α-brass), a pigment from the class of the magnetic pigments (e.g. γ-Fe₂O₃, Fe₃O₄/Fe₂O₃, Cr₂O₃) or other oxides, for example titanium dioxide, oxide hydrates, sulfides, sulfates, carbonates and silicates of the transition metals. This inorganic pigment is preferably carbon black or zinc sulfide.

In a further preferred embodiment of the present invention, the dye is an organic pigment. This organic pigment may be a natural or synthetic pigment.

In a further preferred embodiment, the dye is an organic dye, preferably based on anthraquinone.

In a further preferred embodiment, the organic dye is soluble in at least one aliphatic polyisocyanate in a proportion of >30%, based on the amount thereof used.

In a further preferred embodiment, soluble organic dyes and insoluble organic and/or inorganic dyes (pigments) are mixed for production of the inventive plastics based on crosslinked polyisocyanates.

### Properties of the Plastic of the Invention

In one embodiment of the composite material of the invention, the nitrogen content of the cross-linked polyisocyanate composition A, meaning the total nitrogen bound or present therein divided by the total amount of polymer (each based on weight), is at least 9% by weight, preferably at least 10% by weight, more preferably at least 1% by weight, greater than 12% by weight, greater than 13% and greater than 14% by weight or greater than 15% by weight and most preferably greater than 16% by weight.

The nitrogen content of the plastic can be determined with the aid of the “vario EL cube” elemental analyzer from Elementar Americas, INC. This is done by scraping off a small portion of the material from the plastic and analyzing it in the analysis instrument. First of all, the content of inorganic, noncombustible materials in a portion of the sample taken is determined according to standard DIN EN ISO 1172 Method A.

In a further embodiment of the colored plastic of the invention, the carbon content of the cross-linked polyisocyanate composition A present bound within isocyanurate groups, based on the total carbon content of the polymer matrix, is at least 8%, preferably at least 10%, more preferably at least 12%, greater than 15%, greater than 17% and greater than 19% or greater than 20% and most preferably greater than 23% carbon.

The carbon content bound within isocyanurate groups can be calculated, for example, from the integrals of proton-decoupled ¹³C NMR spectra (MAS NMR, solid-state NMR), since the carbon atoms give characteristic signals in accordance with their bonding, and relate to the sum total of all carbon signals present.

In a further preferred embodiment, the total concentration of urethanes, allophanates, alcohols, amines, thiols, thiourethanes, thioallophanates and biurets in the resin of the composite material, based on the polyisocyanate composition A used, is between 0.1% by weight and 20% by weight.

In a further embodiment of the present invention, in the crosslinked polyisocyanate composition A, the ratio of the sum total of all carbon atoms bound within isocyanurate and iminooxadiazinedione groups and the sum total of all carbon atoms bound within urethanes, allophanates, thiols, thiourethanes, thioallophanates and biurets in the polyisocyanate composition A used is between 500 and 1, preferably between 300 and 1, more preferably between 100 and 1, especially between 50 and 1 and most preferably between 25 and 1.

The proportions of uretdione, urethane, isocyanurate, allophanate, biuret, iminooxadiazinedione and/or oxadiazinetrione structures in the crosslinked polyisocyanate composition A can be calculated, for example, from the integrals of proton-decoupled ¹³C NMR spectra, since the oligomeric structures mentioned give characteristic signals. They each relate to the sum total of uretdione, urethane, isocyanurate, allophanate, biuret, iminooxadiazinedione and/or oxadiazinetrione structures present in the polyisocyanate composition A.

In a further embodiment of the invention, the total concentration of urethanes, allophanates, alcohols, amines, thiols, thiourethanes, thioallophanates, ureas and biurets, based on the cross-linked polyisocyanate composition A in the colored plastic of the invention, is between 20% by weight and 0.1% by weight, preferably between 10% by weight and 0.1% by weight and especially between 5% by weight and 0.1% by weight.

In a further embodiment of the invention, the plastic based on crosslinked polyisocyanates has a glass transition point ≤the glass transition point of the uncolored plastic based on crosslinked polyisocyanates.

In a further embodiment of the invention, the plastic based on crosslinked polyisocyanates has a density ≥the density of the uncolored plastic based on crosslinked polyisocyanates.

### Additives

The polyisocyanurate plastics obtainable by the process of the invention, even as such, i.e. without addition of appropriate auxiliaries and additives, feature very good light stability and/or weathering resistance. Nevertheless, the plastic of the invention may also contain customary additives. These include stabilizers such as antioxidants, light stabilizers, UV stabilizers, antistats, optical brighteners, water and acid scavengers, surface-active additives, defoamers, leveling agents, rheology additives, nucleating agents, transparency enhancers, flame inhibitors and flame retardants, fillers, metal deactivators, slip additives, mold release agents and lubricants such as glycerol monostearate or calcium stearate, nervonic acid, and plasticizers, blowing agents (gases, readily evaporating solvents such as pentane or chemical blowing agents such as azocarbonamide, benzenesulfonyl hydrazide and azobisisobutyronitrile (AIBN)).

These auxiliaries and additives, excluding flame retardants, are typically present in the polyisocyanurate plastic in an amount of less than 30% by weight, preferably less than 10% by weight, more preferably up to 3% by weight, based on the polyisocyanate composition A). Flame retardants are typically present in the polyisocyanurate plastic in amounts of not more than 70% by weight, preferably not more than 50% by weight and more preferably not more than 30% by weight, calculated as the total amount of flame retardants used, based on the total weight of the polyisocyanate composition A).

Suitable UV stabilizers may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or 2,2′-dihydroxy-4-dodecyloxybenzophenone; benzotriazole derivatives, for example 2-(2H-benzotriazol-2-yl)-4,6-ditert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(l-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides, for example 2-ethyl-2′-ethoxy- or 4-methyl-4′-methoxyoxalanilide; salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred light stabilizers may be used either individually or in any desired combinations with one another.

Particularly preferred UV stabilizers for the polyisocyanurate plastics producible in accordance with the invention are those which fully absorb radiation of wavelength <400 nm. These include the recited benzotriazole derivatives for example. Very particularly preferred UV stabilizers are 2-(5-chloro-2H-benzotriazol-2-yl)-6-(1, l-dimethylethyl)-4-methylphenol, 2-(2H-benzotriazol-2-yl)-4-(1,1,3,3-tetramethylbutyl)phenol and/or 2-(5-chloro-2H-benzotriazol-2-yl)-4,6-bis(1,1-dimethylethyl)phenol.

Optionally one or more of the UV stabilizers mentioned by way of example are added to the polyisocyanate composition A), preferably in amounts of 0.001% to 3.0% by weight, more preferably 0.01% to 2% by weight, calculated as the total amount of UV stabilizers used, based on the total weight of the polyisocyanate composition A).

Suitable antioxidants are preferably sterically hindered phenols, which may be selected preferably from the group consisting of vitamin E, 2,6-di-tert-butyl-4-methylphenol (ionol) and derivatives thereof, pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used either individually or in any desired combinations with one another as required.

These antioxidants are preferably used in amounts of 0.01% to 3.0% by weight, more preferably 0.02% to 2.0% by weight, calculated as the total amount of antioxidants used, based on the total weight of the polyisocyanate composition A).

Apart from the small amounts of any catalyst solvents to be used, the formulations of the invention may be solvent-free.

Finally, further auxiliaries and additives added may also be internal mold release agents.

These are preferably the nonionic surfactants containing perfluoroalkyl or polysiloxane units that are known as mold release agents, quaternary alkylammonium salts, for example trimethylethylammonium chloride, trimethylstearylammonium chloride, dimethylethylcetylammonium chloride, triethyldodecylammonium chloride, trioctylmethylammonium chloride and diethylcyclohexyldodecylammonium chloride, acidic monoalkyl and dialkyl phosphates and trialkyl phosphates having 2 to 18 carbon atoms in the alkyl radical, for example ethyl phosphate, diethyl phosphate, isopropyl phosphate, diisopropyl phosphate, butyl phosphate, dibutyl phosphate, octyl phosphate, dioctyl phosphate, isodecyl phosphate, diisodecyl phosphate, dodecyl phosphate, didodecyl phosphate, tridecanol phosphate, bis(tridecanol) phosphate, stearyl phosphate, distearyl phosphate, waxes, for example beeswax, montan wax or polyethylene oligomers, metal salts and esters of oily and fatty acids such as barium stearate, calcium stearate, zinc stearate, glycerol stearate and glycerol laurate, esters of aliphatic branched and unbranched alcohols having 4 to 36 carbon atoms in the alkyl radical, and any desired mixtures of such mold release agents.

Particularly preferred mold release agents are the fatty acid esters and salts thereof mentioned, and also acidic mono- and dialkyl phosphates mentioned, most preferably those having 8 to 36 carbon atoms in the alkyl radical.

Internal mold release agents are used in the process of the invention, if appropriate, preferably in amounts of 0.01% to 15.0% by weight, more preferably 0.02% to 10.0% by weight, especially 0.02% to 5.0% by weight, calculated as the total amount of internal mold release agent used, based on the total weight of the polyisocyanate composition A).

Crosslinking

The “crosslinking” of the polyisocyanate composition A is a process in which the isocyanate groups present in the polyisocyanate composition A react with one another or with urethane groups already present to form uretdione, isocyanurate, allophanate, biuret, iminooxadiazinedione and oxadiazinetrione structures. In this reaction, the isocyanate groups originally present in the polyisocyanate composition A are consumed. The formation of the aforementioned groups results in crosslinking of the monomeric and oligomeric polyisocyanates present in the polyisocyanate composition A. The result is the plastic of the invention. The crosslinking is preferably accelerated by using at least one of the catalysts defined further down in this application.

Since isocyanurate formation, depending on the catalyst used, is frequently accompanied by side reactions, for example dimerization to give uretdione structures or trimerization to form iminooxadiazinediones (called asymmetric trimers), and by allophanatization reactions in the case of presence of urethane groups in the starting polyisocyanate, the terms “trimerization” and “crosslinking” shall also synonymously represent these side reactions that proceed additionally in the context of the present invention.

The effect of the curing of the polyisocyanate composition A is that the nitrogen components bound within uretdione, isocyanurate, biuret and iminooxadiazinedione structures preferably add up to at least 60%, more preferably to at least 65%, especially preferably to at least 70%, 75%, 80%, 85%, 90% and most preferably to at least 95% of the total nitrogen content of the polyisocyanate composition A. It should be taken into account here that, in accordance with the invention, only one of the aforementioned structures has to be present and, depending on the nature of the crosslinking catalyst chosen, one or more of the aforementioned structures may also be completely absent.

In one embodiment of the invention, therefore, at least 60%, more preferably at least 65%, especially preferably at least 70%, 75%, 80%, 85%, 90% and most preferably at least 95% of the total nitrogen content of the polyisocyanate composition A after curing is bound within uretdione, isocyanurate, biuret and iminooxadiazinedione structures.

Preferably, the effect of the crosslinking reaction is that not more than 20%, preferably not more than 10%, more preferably not more than 5%, even more preferably not more than 2% and especially not more than 1% of the total nitrogen content of the polyisocyanate composition A is present in urethane and/or allophanate groups.

In a particularly preferred embodiment of the invention, the cured polyisocyanate composition A, however, is not entirely free of urethane and allophanate groups. For that reason, it preferably contains at least 0.1% of urethane and/or allophanate groups based on the total nitrogen content.

In a particular embodiment, however, crosslinking means that predominantly cyclotrimerizations of at least 50%, preferably at least 60%, more preferably at least 70%, especially at least 80% and most preferably 90% of the isocyanate groups present in the polyisocyanate composition A to give isocyanurate structural units are catalyzed. Thus, in the finished plastic, corresponding proportions of the nitrogen originally present in the polyisocyanate composition A are bound within isocyanurate structures. However, side reactions, especially those to give uretdione, allophanate and/or iminooxadiazinedione structures, typically occur and can even be used in a controlled manner in order to advantageously affect, for example, the glass transition temperature (T_{g}) of the plastic obtained. However, the above-defined content of urethane and/or allophanate groups is preferably present in this embodiment too.

Catalyst

Suitable catalysts for production of the colored plastic of the invention are in principle any compounds which accelerate the trimerization of isocyanate groups to isocyanurate structures.

Since isocyanurate formation, depending on the catalyst used, is frequently accompanied by side reactions, for example dimerization to give uretdione structures or trimerization to form iminooxadiazinediones (called asymmetric trimers), and by allophanatization reactions in the case of presence of urethane groups in the starting polyisocyanate, the term “trimerization” shall also synonymously represent these reactions that proceed additionally in the context of the present invention.

In a particular embodiment, however, trimerization means that predominantly cyclotrimerizations of at least 50%, preferably at least 60%, particularly preferably at least 70%, in particular at least 80%, of the isocyanate groups present in the composition A) to give isocyanurate structural units are catalyzed. However, side reactions, especially those to give uretdione, allophanate and/or iminooxadiazinedione structures, typically occur and can even be used in a controlled manner in order to advantageously affect, for example, the Tg value of the polyisocyanurate plastic obtained.

Suitable catalysts are, for example, simple tertiary amines, for example triethylamine, tributylamine, N,N-dimethylaniline, N-ethylpiperidine or N,N′-dimethylpiperazine. Suitable catalysts also include the tertiary hydroxyalkylamines described in GB-A 2 221 465, for example triethanolamine, N-methyldiethanolamine, dimethylethanolamine, N-isopropyldiethanolamine and 1-(2-hydroxyethyl)pyrrolidine or the catalyst systems known from GB-A 2 222 161 that consist of mixtures of tertiary bicyclic amines, for example DBU, with simple aliphatic alcohols of low molecular weight.

Suitable trimerization catalysts are likewise a multitude of different metal compounds, for example the octoates and naphthenates of manganese, iron, cobalt, nickel, copper, zinc, zirconium, cerium or lead or mixtures thereof with acetates of lithium, sodium, potassium, calcium or barium that are described as catalysts in DE-A 3 240 613, the sodium and potassium salts of linear or branched alkanecarboxylic acids having up to 10 carbon atoms that are known from DE-A 3 219 608, for example of propionic acid, butyric acid, valeric acid, caproic acid, heptanoic acid, caprylic acid, pelargonic acid, capric acid and undecylenoic acid, the alkali metal or alkaline earth metal salts of aliphatic, cycloaliphatic or aromatic mono- and polycarboxylic acids having 2 to 20 carbon atoms that are known from EP-A 0 100 129, for example sodium or potassium benzoate, the alkali metal phenoxides known from GB-A 1 391 066 and GB-A 1 386 399, for example sodium or potassium phenoxide, the alkali metal and alkaline earth metal oxides, hydroxides, carbonates, alkoxides and phenoxides known from GB-A 0 809 809, alkali metal salts of enolizable compounds and metal salts of weak aliphatic or cycloaliphatic carboxylic acids, for example sodium methoxide, sodium acetate, potassium acetate, sodium acetoacetate, lead 2-ethylhexanoate and lead naphthenate, the basic alkali metal compounds complexed with crown ethers or polyether alcohols that are known from EP-A 0 056 158 and EP-A 0 056 159, for example complexed sodium or potassium carboxylates, the pyrrolidinone-potassium salt known from EP-A 0 033 581, the mono- or polynuclear complex of titanium, zirconium and/or hafnium known from application EP-A 2 883 895 (EP 13 196 508.9), for example zirconium tetra-n-butoxide, zirconium tetra-2-ethylhexanoate and zirconium tetra-2-ethylhexoxide, and tin compounds of the kind described in European Polymer Journal, vol. 16, 147-148 (1979), for example dibutyltin dichloride, diphenyltin dichloride, triphenylstannanol, tributyltin acetate, tributyltin oxide, tin dioctoate, dibutyl(dimethoxy)stannane and tributyltin imidazolate.

Further suitable trimerization catalysts are, for example, the quaternary ammonium hydroxides known from DE-A 1 667 309, EP-A 0 013 880 and EP-A 0 047 452, for example tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2]octane hydroxide (monoadduct of ethylene oxide and water onto 1,4-diazabicyclo[2.2.2]octane), the quaternary hydroxyalkylammonium hydroxides known from EP-A 0 003 765 or EP-A 0 010 589, for example N,N,N-trimethyl-N-(2-hydroxyethyl)ammonium hydroxide, the trialkylhydroxylalkylammonium carboxylates that are known from DE-A 2 631 733, EP-A 0 671 426, EP-A 1 599 526 and U.S. Pat. No. 4,789,705, for example N,N,N-trimethyl-N-2-hydroxypropylammonium p-tert-butylbenzoate and N,N,N-trimethyl-N-2-hydroxypropylammonium 2-ethylhexanoate, the quaternary benzylammonium carboxylates known from EP-A 1 229 016, for example N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium 2-ethylhexanoate or N,N,N-tributyl-N-(4-methoxybenzyl)ammonium pivalate, the tetrasubstituted ammonium α-hydroxycarboxylates known from WO 2005/087828, for example tetramethylammonium lactate, the quaternary ammonium or phosphonium fluorides known from EP-A 0 339 396, EP-A 0 379 914 and EP-A 0 443 167, for example N-methyl-N,N,N-trialkylammonium fluorides with C₈-C₁₀-alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride, the quaternary ammonium and phosphonium polyfluorides known from EP-A 0 798 299, EP-A 0 896 009 and EP-A 0 962 455, for example benzyltrimethylammonium hydrogen polyfluoride, the tetraalkylammonium alkylcarbonates which are known from EP-A 0 668 271 and are obtainable by reaction of tertiary amines with dialkyl carbonates, or betaine-structured quaternary ammonioalkyl carbonates, the quaternary ammonium hydrogencarbonates known from WO 1999/023128, for example choline bicarbonate, the quaternary ammonium salts which are known from EP-A 0 102 482 and are obtainable from tertiary amines and alkylating esters of phosphorus acids, examples of such salts being reaction products of triethylamine, DABCO or N-methylmorpholine with dimethyl methanephosphonate, or the tetrasubstituted ammonium salts of lactams that are known from WO 2013/167404, for example trioctylammonium caprolactamate or dodecyltrimethylammonium caprolactamate.

Further suitable trimerization catalysts can be found, for example, in J. H. Saunders and K. C. Frisch, Polyurethanes Chemistry and Technology, p. 94 if. (1962) and the literature cited therein.

The catalysts may be used either individually or in the form of any mixtures with one another.

Preferred catalysts are metal compounds of the aforementioned type, especially carboxylates and alkoxides of alkali metals, alkaline earth metals or zirconium, and organic tin compounds of the type mentioned.

Particularly preferred trimerization catalysts are sodium and potassium salts of aliphatic carboxylic acids having 2 to 20 carbon atoms and aliphatically substituted tin compounds.

Very particularly preferred trimerization catalysts are potassium acetate, tin dioctoate and/or tributyltin oxide.

In one embodiment of the invention, the catalytic trimerization takes place in the presence of a trimerization catalyst, where the trimerization catalyst preferably comprises at least one alkali metal salt or alkaline earth metal salt.

In a preferred embodiment of the invention, the trimerization catalyst comprises potassium acetate as alkali metal salt and/or a polyether, especially a polyethylene glycol.

The trimerization catalyst is generally used in a concentration based on the amount of the polyisocyanate composition A used of 0.0005% to 15.0% by weight, preferably of 0.05% to 13.0% by weight or preferably of 0.1% to 10.0% by weight, and more preferably of 0.2% to 5.0% by weight, most preferably of 0.5 to 3.0% by weight.

Catalysts may, if necessary, be dissolved in suitable, preferably non-isocyanate-reactive, solvents to improve their miscibility with the polyisocyanate composition A. These are known to those skilled in the art.

### Fillers

In a further embodiment, the present invention relates to a colored plastic based on cross-linked polyisocyanates containing at least 5% by weight of an inorganic filler based on the sum of the total weight of the polyisocyanate composition A, dye and inorganic filler.

Suitable fillers are, for example, Al(OH)₃, CaCO₃, silicon dioxide, magnesium carbonate, minerals containing silicates, sulfates, carbonates and the like, such as magnesite, barite, mica, dolomite, kaolin, clay minerals, metal or metal oxide particles such as TiO₂ and other known conventional fillers. These fillers are preferably used in amounts of not more than 80% by weight, preferably not more than 60% by weight, more preferably not more than 40% by weight, calculated as the total amount of fillers used, based on the total weight of the polyisocyanate composition A).

In a further embodiment, the present invention relates to a colored plastic based on cross-linked polyisocyanates containing at least 5% by weight of a fibrous filler based on the sum of the total weight of the polyisocyanate composition A, dye and fibrous filler.

Suitable fibrous fillers are, for example, all inorganic fibers, organic fibers, natural fibers or mixtures thereof that are known to those skilled in the art.

Fibrous fillers are understood to mean materials wherein the aspect ratio, i.e. the length divided by the diameter, is greater than 5, preferably greater than 20, especially greater than 50 and more preferably greater than 100.

Examples of the inorganic fibers that are suitable in accordance with the invention are glass fibers, carbon fibers, basalt fibers, boron fibers, ceramic fibers, whiskers, silica fibers and metallic reinforcing fibers. Examples of organic fibers that are suitable in accordance with the invention are aramid fibers, carbon fibers, polyester fibers, nylon fibers and Plexiglas fibers. Examples of natural fibers that are suitable in accordance with the invention are flax or hemp fibers, wood fibers, cellulose fibers and sisal fibers.

### Process

In a further embodiment, the present invention relates to a process for producing a colored plastic based on crosslinked polyisocyanates, comprising the process steps of
a) mixing the polyisocyanate composition A with at least one pigment, at least one fibrous filler having an aspect ratio of at least 100 and at least one crosslinking catalyst; and
b) catalytically crosslinking the polyisocyanate composition A to give the colored plastic, wherein, at the end of the catalytic crosslinking, the nitrogen components bound within uretdione, isocyanurate, biuret and iminooxadiazinedione structures add up to at least 60% of the total nitrogen content of the polyisocyanate composition A.

The resultant plastic is preferably an isocyanurate plastic. A “polyisocyanurate plastic” is a plastic as described above in this application which is characterized by the presence of isocyanurate groups.

In principle, suitable catalysts for the process of the invention are all catalysts described in this application.

The catalytic crosslinking preferably takes place in a temperature range between 30 and 250° C. It is preferably largely complete within not more than 6 hours. “Largely complete” means that at least 80% of the reactive isocyanate groups present in the polyisocyanate composition A at the start of process step a) have been consumed.

The working examples which follow serve to illustrate the invention. They are not intended to limit the scope of protection of the patent claims in any way.

### EXAMPLES

### General Details:

In the examples, all percentages are to be understood as meaning percent by weight, unless otherwise stated.

The ambient temperature of 23° C. at the time of performance of the experiments is referred to as RT (room temperature).

### Test Methods:

The methods detailed hereinafter for determination of the appropriate parameters were used for performance and evaluation of the examples and are also the methods for determination of the parameters of relevance in accordance with the invention in general.

### Determination of Phase Transitions by DSC:

The phase transitions were determined by means of DSC (differential scanning calorimetry) with a Mettler DSC 12E (Mettler Toledo GmbH, Giessen, Germany) in accordance with DIN EN 61006. Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 320 K/min. Cooling was effected by means of liquid nitrogen. The purge gas used was nitrogen. The values reported are each based on the evaluation of the 1st heating curve, since changes in the sample in the measurement process at high temperatures are possible in the reactive systems being examined as a result of the thermal stress in the DSC. The melting temperatures Tₘ were obtained from the temperatures at the maxima of the heat flow curves. The glass transition temperature T_{g} was obtained from the temperature at half the height of a glass transition step.

### Determination of Infrared Spectra:

The infrared spectra were measured on a Bruker FT-IR spectrometer equipped with an ATR unit.

### Starting Compounds:

Polyisocyanate A1: Desmodur® N 3600 is an HDI trimer (NCO functionality >3) with an NCO content of 23.0% by weight from Covestro Deutschland AG. The viscosity is about 1200 mPas at 23° C. (DIN EN ISO 3219/A.3). Before use, the material was degassed under reduced pressure.

Polyethylene glycol (PEG) 400 was sourced from ACROS with a purity of >99% by weight and dried before use and degassed under reduced pressure.

Potassium acetate was sourced with a purity of >99% by weight from ACROS.

Dyes used were the following substances:
carbon black (Printex® G from Orion Engineered Carbons)
organic dyes (Makrolex® Green 5B from Lanxess), an anthraquinone dye
zinc sulfide in carrier medium (UPL-10478 from Chromaflo)

### Preparation of Catalyst Solution K1:

Potassium acetate (5.0 g) was stirred in PEG 400 (95.0 g) at RT until all of it had dissolved. In this way, a 5% by weight solution of potassium acetate in PEG 400 (K1) was obtained and was used as trimerization catalyst without further treatment.

### Production of the Color Paste:

25 g in each case of the dyes was added to 75 g of polyisocyanate Al and dispersed in a Speedmixer DAC 150.1 FVZ from Hauschild at 2750 min-1 for 5 min. UPL-10478 was used as obtained without dispersion in polyisocyanate Al.

### Production of the Colored Polyisocyanurates:

The reaction mixture was prepared by mixing 38.4 g of polyisocyanate Al with 1.6 g of the catalyst solution at 23° C. for 3 min in a Speedmixer DAC 150.1 FVZ from Hauschild at 2750 min−1. This was then admixed with an appropriate amount of color paste, poured into a suitable mold for crosslinking and then crosslinked in an oven at 180° C. for 5 min.

### Working Example 1

As described above, 40 g of the reaction mixture was admixed with 2 g of a color paste based on Printex® G and polyisocyanate Al and cured in an oven. This gave a homogeneous, black-colored plastic having a glass transition temperature of about 100° C. The conversion was >90% (determined by IR spectroscopy, decrease in the NCO band at 2270 cm-1).

### Working Example 2

As described above, 40 g of the reaction mixture was admixed with 2 g of a color paste based on Makrolex® Green 5B and polyisocyanate Al and cured in an oven. This gave a homogeneous, green-colored plastic having a glass transition temperature of about 100° C. The conversion was >90% (determined by IR spectroscopy, decrease in the NCO band at 2270 cm−1).

### Working Example 3

As described above, 40 g of the reaction mixture was admixed with 2 g of the color paste UPL-10478 and cured in an oven. This gave a homogeneous, white-colored plastic having a glass transition temperature T_{g} of about 95° C. The conversion was >90% (determined by IR spectroscopy, decrease in the NCO band at 2270 cm−1).

1.-9. (canceled)

10. A colored plastic obtained by the catalytic crosslinking of a polyisocyanate composition A in the presence of at least one pigment, wherein (i) the plastic contains at least 5% by weight of a fibrous filler having an aspect ratio of at least 100, based on the sum total of the weights of polyisocyanate composition A, dye and fibrous filler; and (ii) the nitrogen components bound within uretdione, isocyanurate, biuret and iminooxadiazinedione structures add up to at least 60% of the total nitrogen content of the polyisocyanate composition A.

11. The colored plastic as claimed in claim 10, wherein at least 8% by weight of the carbon present in the polyisocyanate composition A is bound within isocyanurate groups.

12. The colored plastic as claimed in claim 10, wherein the ratio of the sum total of all carbon atoms bound within isocyanurate and iminooxadiazinedione groups and the sum total of all carbon atoms bound within urethanes, allophanates, thiols, thiourethanes, thioallophanates, ureas and biurets in the cured polymer matrix of the composite material of the invention is between 500 and 1.

13. The colored plastic as claimed in claim 10, wherein the pigment is carbon black or zinc sulfide.

14. The colored plastic as claimed in claim 10 having a glass transition point ≤the glass transition point of the uncolored plastic based on crosslinked polyisocyanates.

15. The colored plastic as claimed in claim 10 having a density ≥the density of the uncolored plastic based on crosslinked polyisocyanates.

16. The colored plastic as claimed in claim 10, wherein the plastic includes the pigment in an amount within a range from 0.05% to 20% by weight, based on the total weight of the colored plastic.

17. A shaped body produced from the colored plastic as claimed in claim 10.

18. A process for producing a colored plastic based on crosslinked polyisocyanates, comprising the process steps of
a) mixing the polyisocyanate composition A with at least one pigment, at least one fibrous filler having an aspect ratio of at least 100 and at least one crosslinking catalyst; and
b) catalytically crosslinking the polyisocyanate composition A to give the colored plastic, wherein, at the end of the catalytic crosslinking, the nitrogen components bound within uretdione, isocyanurate, biuret and iminooxadiazinedione structures add up to at least 60% of the total nitrogen content of the polyisocyanate composition A.
